(19) United States
(12) Patent Application Publication
(10) Pub. No.: US 2009/0158868 A1
(43) Pub. Date: Jun. 25, 2009

(54) Crank-Type Linear Actuator

(75) Inventors: William Farmer, Westford, MA (US); Nathaniel Hockenberry, Halifax, MA (US); Thomas P. Schregardus, Somerville, MA (US); Michael Baker, Dedham, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: STONERIDGE CONTROL DEVICES, INC., Canton, MA (US)

(21) Appl. No.: 12/325,635

(22) Filed: Dec. 1, 2008

Related U.S. Application Data
(60) Provisional application No. 60/991,344, filed on Nov. 30, 2007.

(51) Int. Cl. F16H 21/24

(52) U.S. Cl. 74/49

(57) ABSTRACT

A crank-type linear actuator may be used to provide linear actuation, for example, in a vehicle system. In general, the actuator may use a crank assembly to convert a unidirectional rotary drive motion into a reciprocating linear actuation motion. The actuator may also use magnetic elements and magnetic sensors for non-contact position control of the actuator.

### CROSS-REFERENCE TO RELATED APPLICATIONS

This application claims the benefit of co-pending U.S. Provisional Patent Application Ser. No. 60/991,344, filed on Nov. 30, 2007, which is fully incorporated herein by reference.

### TECHNICAL FIELD

The present disclosure relates in general to actuators and more particularly, to a crank-type linear actuator for use in vehicle systems.

### BACKGROUND INFORMATION

In recent years, commercial vehicles, sport utility vehicles and passenger vehicles capable of full-time or part-time 4-wheel drive and/or all-wheel-drive operation have become commonplace. In some configurations, the operator has the option of selecting 2-wheel or 4-wheel drive depending on the conditions at any given time. The vehicle may also, or alternatively, be configured to automatically move from one drive train or suspension operating condition to another condition based on road conditions sensed by the vehicle. For example, the vehicle may move from 2-wheel drive to 4-wheel drive, or may selectively drive particular wheels, when slippery road conditions are encountered. Connection and disconnection of a vehicle suspension stabilizer may also be established, either manually or automatically, due to road conditions.

To establish these changes in drive train or suspension operating conditions, a vehicle may be equipped with one or more electro-mechanical actuators, e.g. for changing the state of the front and/or rear differential, transfer case, and/or stabilizer bar system. Cost and reliability of such actuators are, of course, important considerations.

### BRIEF DESCRIPTION OF THE DRAWINGS

These and other features and advantages will be better understood by reading the following detailed description, taken together with the drawings wherein:

FIG. 1 is a partially cross-sectional view of one exemplary embodiment of an actuator associated with a differential of a 4-wheel drive vehicle;

FIGS. 2A and 2B are perspective views of an embodiment of an actuator consistent with the disclosure;

FIGS. 3A-3F are side views of an embodiment of an actuator including a crank assembly and drive train in successive positions, consistent with the present disclosure; and

FIGS. 4A-4D are side views of a crank assembly in successive positions in an embodiment of an actuator including non-contact position control, consistent with the present disclosure.

### DETAILED DESCRIPTION

A crank-type linear actuator, consistent with the present disclosure, may be used to provide linear actuation, for example, in a vehicle system. In general, the actuator may use a crank assembly to convert a unidirectional rotary drive motion into a reciprocating linear actuation motion. The actuator may also use magnetic elements and magnetic sensors for non-contact position control of the actuator, as will be described in greater detail below.

For ease of explanation, an actuator consistent with the disclosure is described herein in connection operation of a differential, i.e. a front differential, of a 4-wheel drive vehicle. However, an actuator consistent with the disclosure may be useful in establishing a change of operating condition or lock state in a variety applications, in and out of vehicles. For example, an actuator consistent with the disclosure may be used to manipulate the condition of a vehicle front differential, rear differential, transfer case, stabilizer bar system, lock/unlock a steering column, etc. The illustrated exemplary embodiments described herein are provided only by way of illustration and are not intended to be limiting.

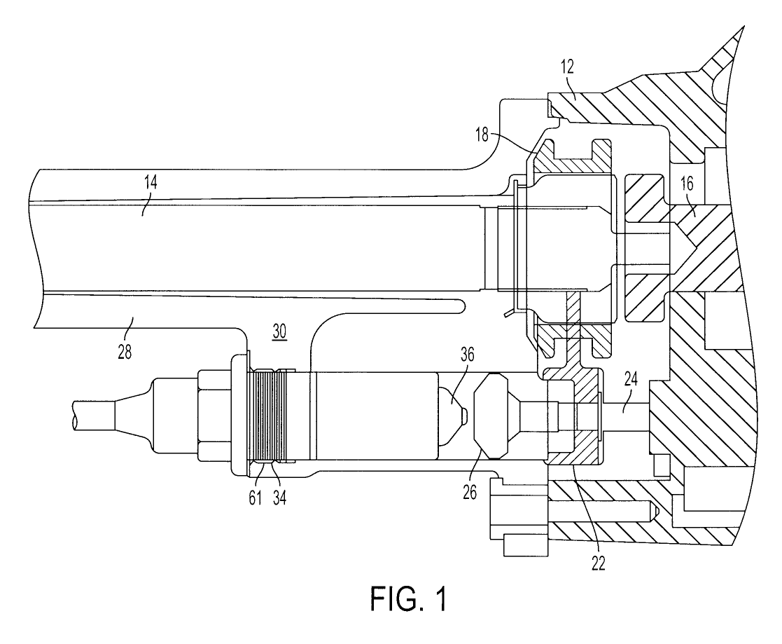

Referring to FIG. 1, an actuator 34, consistent with the present disclosure, is shown in a front differential housing 12 similar to those utilized in some 4-wheel drive vehicles. A wheel output shaft 14 extends out from the housing 12 to the left and a differential output shaft 16 extends outward through the housing 12 to the right. Although one type of differential is illustrated, an actuator consistent with the present disclosure may be used to cause torque transfer between shafts in any type of differential or other torque transfer system. In one vehicle configuration, when the vehicle is proceeding normally with 2-wheel drive in operation, only the rear wheels may be driving the vehicle and the front differential may be set up as it appears in FIG. 1. In other words, there may be no direct connection between the differential output shaft 16 and the wheel output shaft 14.

A coupling sleeve or ring, such as an internally splined ring 18, may be used to provide a connection between the differential output shaft 16 and the wheel output shaft 14. The splined ring 18 may be coupled with both of the shafts 14, 16 in an engaged position to provide the connection and may be decoupled from one of the shafts 14, 16 in a disengaged position. The splined ring 18, for example, may be engaged on the externally splined end of the wheel output shaft 14 in the disengaged position and may be movable axially into engagement with splines on the exterior of the differential output shaft 16 in the engaged position. Other types of coupling rings or sleeves may also be used to engage both the wheel output shaft 14 and the differential output shaft 16.

An engaging member, such as a fork 22, may be used to engage and control the axial position of the splined ring 18 on the wheel output shaft 14 and the differential output shaft 16. The fork 22 may be mounted on a reciprocating shaft 24 having an end knob 26 and may be normally urged in a leftward direction by a spring (not shown). Movement of the shaft 24 against the spring, for example, causes the fork 22 to move the splined ring 18 from the disengaged position to the engaged position. Other types of engaging members may also be used to engage and move the splined ring 18 or other coupling sleeve or ring.

The actuator 34 may be used to cause the fork 22 or other type of engaging member to move linearly. The wheel output shaft 14 may be surrounded by an enclosure 28 having a radial extension 30. In the illustrated exemplary embodiment, the extension 30 includes an opening formed through its wall, which is threaded to receive matching threads 61 of the body of the actuator 34. The actuator 34 may include a plunger 36, which is linearly reciprocable (i.e., in an actuation direction and a retraction direction) in an actuator body. The plunger 36 may contact the knob 26 and in its forward motion out of the actuator body, push the knob and its support shaft 24 from left to right as seen in the drawing. As the shaft 24 moves to the right, the shaft 24 carries the fork 22 with it against spring pressure and the splined ring 18 is moved from left to right to engage the splines on the exterior of the differential output shaft 16 if they are aligned with the splines of the ring 18.

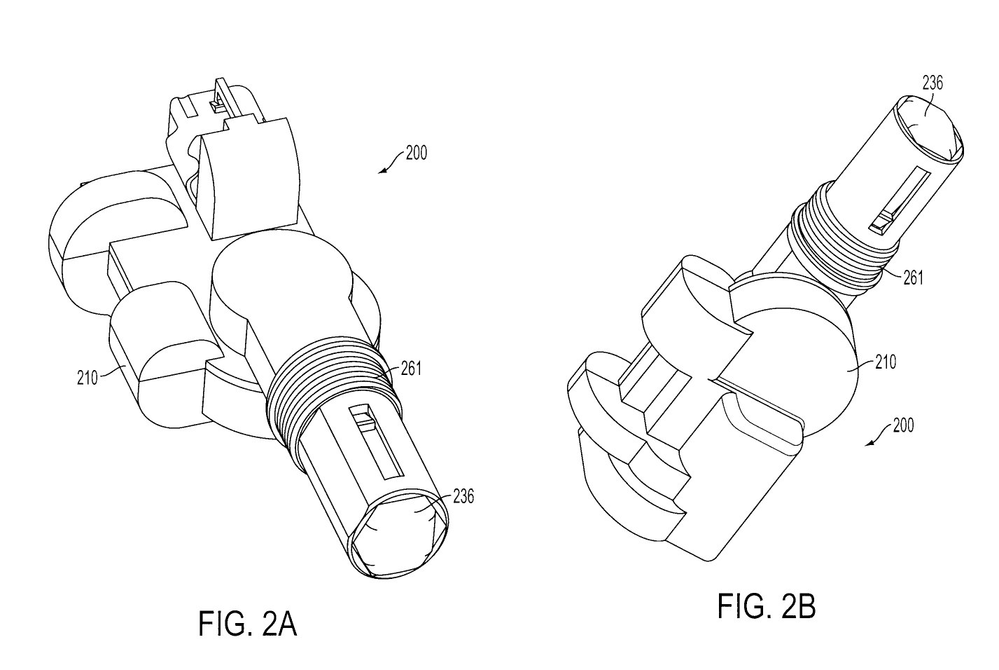

FIGS. 2A and 2B are perspective views of an exemplary embodiment of an actuator 200, consistent with the present disclosure, which may be used to provide linear actuation in the differential described above or in other vehicle systems. The actuator 200 may include a housing 210 enclosing a crank assembly and drive train (not shown) that moves the plunger 236 in the actuation and retraction directions. The actuator 200 may also include threads 261 configured to engage threads, for example, in the extension 30 described above or in another structure in a vehicle system.

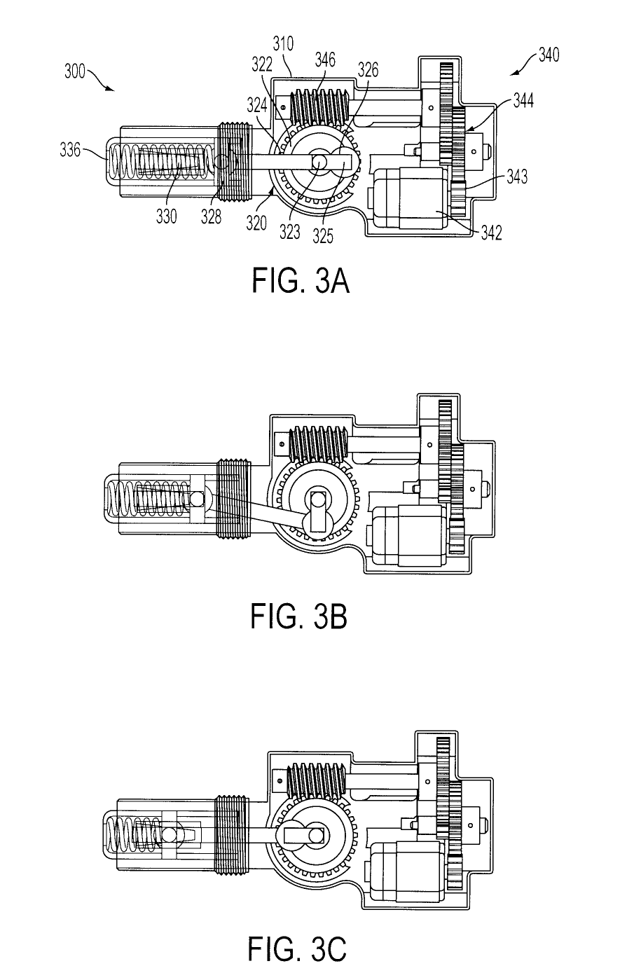

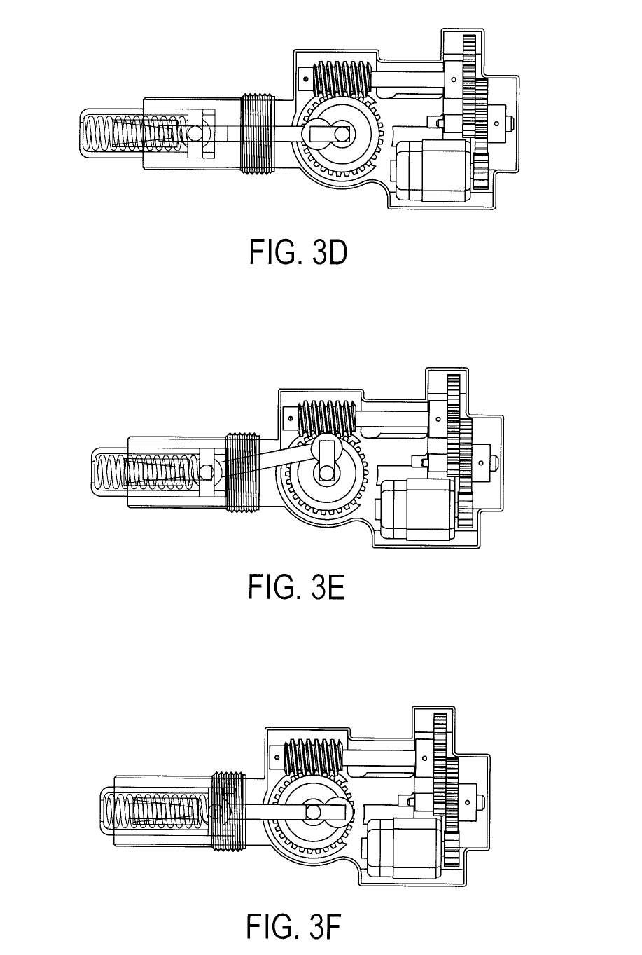

Referring to FIGS. 3A-3F, an embodiment of an actuator 300 including a crank assembly 320 and drive train 340 is shown in various positions and described in greater detail. In general, the drive train 340 drives the crank assembly 320 to provide the linear actuation. The crank assembly 320 and the drive train 340 may be enclosed in a housing 310. For simplicity and clarity, reference numerals are used only in FIG. 3A.

The crank assembly 320 includes a drive wheel 322 and a crank 324 coupled to the drive wheel 322. The crank 324 is pivotably coupled at a first end to the drive wheel 322 and pivotably coupled at a second end to the plunger 336. The crank 324 pivots at the first end about a pivot axis 325 that is spaced radially from a rotation axis 323 of the drive wheel 322. Thus, rotation of the drive wheel 322 in one direction causes the first end of the crank 324 to travel in a circular path, e.g. in a direction around the perimeter of the drive wheel 322, which causes the second end of the crank 324 to move in a linear direction, thereby causing linear translation of the plunger 336. In the illustrated embodiment, the first end of the crank 324 may be coupled to the drive wheel 322 through a radial arm 326 that provides the radial spacing, although the crank 324 may also be coupled in other ways.

The second end of the crank 324 may be pivotally coupled to the plunger 336 through a slider 328 that is slidably disposed within a plunger portion of the housing 310. The slider 328 may translate along the interior of the plunger portion upon rotation of the drive wheel 322, as shown in FIGS. 3A-3F. The slider 328 may be coupled to the plunger 336 through a spring element, such as compression spring 330. Thus, the force of the compression spring 330 causes the plunger 336 to move in the actuation direction to the actuated position. The slider 328 may directly engage the plunger 336 when moving in the retraction direction to move the plunger 336 back to the retracted position. In other embodiments, the crank 324 may be pivotably coupled to the plunger 336 in other ways, for example, by direct coupling. Also, other types of spring elements may be used such as, for example, a compressible resilient material.

The drive train 340 may include an electric motor 342 (e.g., a DC motor) coupled to a reduction gear train 344 through a pinion gear 343 coupled to the motor output shaft. The motor 342 may be a reversible motor or may have only unidirectional output. In an embodiment, the drive wheel 322 may be a worm drive wheel and the drive train 340 may also include a worm gear 346 in meshing engagement with the worm drive wheel 322. Energizing the motor 342 may thus drive the worm drive wheel 322 through the gear train 344 and the worm gear 346. The motor 342 may be driven by a drive signal, e.g. from a vehicle bus, to control the positioning of the plunger 336, as described in greater detail below. The motor 342 may also be coupled to the drive wheel 322 directly or using another gear train configuration (e.g., without a worm gear).

In operation, the actuator 300 starts in a retracted position (FIG. 3A), moves to an actuated position (FIG. 3D), and returns to a retracted position (FIG. 3F). In a fully actuated position shown in FIG. 3D, for example, the plunger may force a vehicle into 4-wheel drive mode, while in a fully retracted position shown in FIGS. 3A and 3F, the vehicle may be in a 2-wheel drive mode. The movement of the actuator 300 from the retracted position to the actuated position and back to the retracted position may be accomplished through the crank assembly 320 with a unidirectional drive train motion. As shown, for example, the drive train 340 rotates the drive wheel 322 in a clockwise direction to move from the retracted position to the actuated position and back to the retracted position.

The actuator 300 may also allow actuation under blocked and unblocked conditions. When a blocked condition occurs, the plunger 336 is blocked from outward movement by an external element, e.g. interference between teeth of the splined ring. When the drive wheel 322 begins to rotate and the plunger 336 is blocked, the slider 328 slides relative to the plunger 336 and compresses the compression spring 330 as shown in FIG. 3B (partial actuation under a blocked condition) and FIG. 3C (full actuation under a blocked condition). When the blocked condition is removed, the compression spring 330 may force the plunger 336 outwardly (i.e., in the actuation direction) to the actuated position, as shown in FIG. 3D. When the worm drive wheel 322 continues to rotate, the slider 328 may then cause the plunger 336 to move back inwardly (i.e., in the retraction direction) either by directly engaging the plunger 336 or indirectly through the compression spring 330, as shown in FIG. 3E (partial retraction) and FIG. 3F (full retraction).

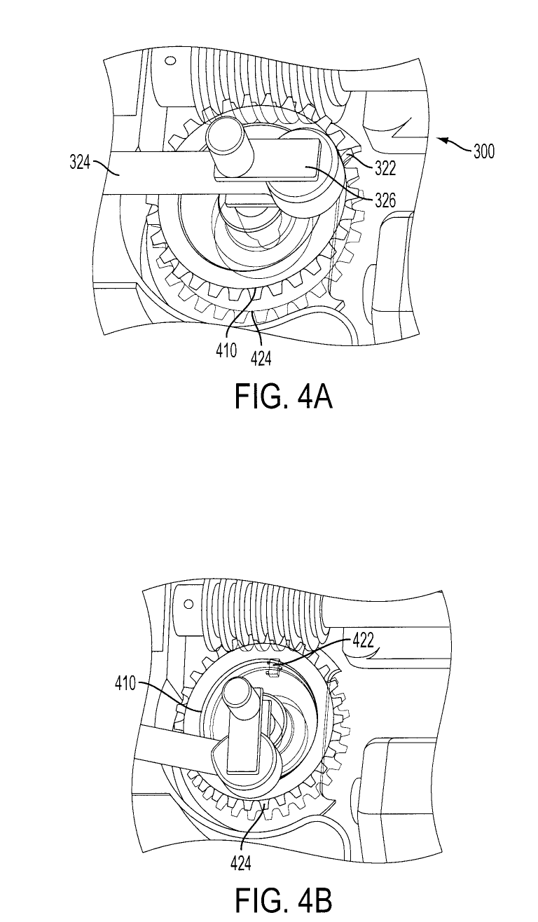

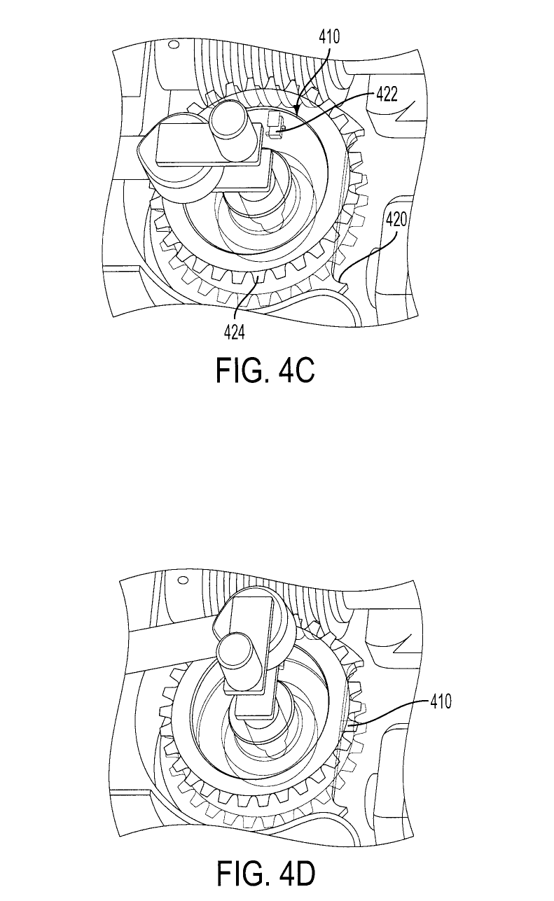

Referring to FIGS. 4A-4D, the actuator 300, consistent with the present disclosure, may also use non-contacting position control. One or more magnetic elements 410 may be fixed to the drive wheel 322 such that the magnetic elements 410 rotate with the drive wheel 322. One or more magnetic sensors, such as Hall-effect switches 422, 424, may be positioned relative to the drive wheel 322 to sense the proximity of the magnetic element(s) 410 when the drive wheel 322 rotates. The magnetic sensor(s) thus sense the rotational position of the drive wheel 322 and, hence, the position of the plunger. In the illustrated exemplary embodiment, first and second stationary Hall-effect switches 422, 424 are placed 180 degrees apart relative to the circumference of the drive wheel 322, and a single magnet 410 is coupled to the drive wheel 322 for rotation therewith. As the drive wheel 322 rotates, the magnet 410 passes the Hall-effect switches 422, 424, thereby changing their state and indicating the position of the drive wheel 322 and the plunger. The Hall-effect switches 322, 324 may be mounted, for example, on a circuit board 420 located within a housing of the actuator 300.

FIGS. 4A-4D illustrate successive positions, respectively, of the worm wheel 322 and magnet 410 compared to the Hall-effect switches 422, 424, according to an embodiment. The magnet 410 is disposed over a Hall-effect switch 424 (i.e., at 6 o'clock) in an initial retracted position (FIG. 4A) and the magnet 410 is disposed over a Hall-effect switch 422 (i.e., at 12 o'clock) in a fully actuated position (FIG. 4A). In the partially actuated position (FIG. 4B) and the partially retracted position (FIG. 4D), the magnet 410 is between the Hall-effect switches 422, 424. The outputs of the Hall-effect switches 422, 424 may thus be monitored to determine the position of the plunger. This position information may be provided to a vehicle controller for energizing the motor to establish a desired position for the plunger, e.g. to place a vehicle in 4-wheel or 2-wheel drive in response to an operator input/selection. Although the exemplary embodiment shows Hall-effect switches 422, 424 at specific positions, the Hall-effect switches 422, 424 or other type of magnetic sensor(s) may be used at other locations.

Accordingly, the crank-type linear actuator, consistent with the present disclosure, is capable of being driven with a unidirectional drive train, which may simplify circuit design, reduce motor size and peak current, and reduce EMC and motor drive component costs. The actuator may also use non-contact position control to improve reliability.

Consistent with one embodiment, an actuator includes a drive wheel rotatable about a rotation axis and an electric motor for driving the drive wheel such that the drive wheel rotates about the rotation axis. The actuator also includes a crank having a first end and a second end with the first end being pivotably coupled to the drive wheel such that the crank pivots about a pivot axis parallel to and spaced radially from the rotation axis of the drive wheel. The actuator further includes a plunger engaged by the second end of the crank such that the crank causes translation of the plunger between at least a retracted position and an actuated position when the drive wheel rotates in one direction of rotation about the rotation axis and the crank pivots about the pivot axis.

Consistent with another embodiment, an actuator includes a worm gear; a worm drive wheel engaged by the worm gear and rotatable about a rotation axis; and an electric motor for driving the worm gear such that worm gear drives the worm drive wheel about the rotation axis. The actuator also includes a crank having a first end and a second end with the first end being pivotably coupled to the drive wheel such that the crank pivots about a pivot axis parallel to and spaced radially from the rotation axis of the drive wheel. The actuator further includes a slider coupled to the second end of the crank such that rotation of the drive wheel in one direction of rotation causes the crank to move the slider linearly in an actuation direction and in a retraction direction opposite the actuation direction. The actuator also includes a spring element engaging the slider and a plunger engaged by the spring element such that translation of the slider in the actuation direction causes the spring element to move the plunger in the actuation direction to an actuated position and translation of the slider in the retraction direction causes the plunger to move in the retraction direction to a retracted position. The actuator further includes a magnetic element fixed to the drive wheel such that the magnetic element rotates with the drive wheel and at least one magnetic sensor positioned such that the magnetic element passes the magnetic sensor when the drive wheel rotates for detecting a position of the plunger.

Consistent with a further embodiment, a torque transfer system includes a first shaft, a second shaft for transmitting torque to the first shaft, and a coupling sleeve configured to move between engaged and disengaged positions relative to the first and second shafts. The sleeve couples the first and second shafts for transmission of torque therebetween in the engaged position and is decoupled from at least one of the first and second shafts in the disengaged position. The torque transfer system further includes an actuator for causing the sleeve to move between the engaged and disengaged positions. The actuator includes a drive wheel rotatable about a rotation axis and an electric motor for driving the drive wheel such that the drive wheel rotates about the rotation axis. The actuator also includes a crank having a first end and a second end with the first end being pivotably coupled to the drive wheel such that the crank pivots about a pivot axis parallel to and spaced radially from the rotation axis of the drive wheel. The actuator further includes a plunger engaged by the second end of the crank such that the crank causes translation of the plunger between at least a retracted position and an actuated position when the drive wheel rotates in one direction of rotation about the rotation axis and the crank pivots about the pivot axis.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An actuator comprising:
a drive wheel rotatable about a rotation axis;
an electric motor for driving the drive wheel such that the drive wheel rotates about the rotation axis;
a crank having a first end and a second end, the first end being pivotably coupled to the drive wheel such that the crank pivots about a pivot axis, the pivot axis being parallel to and spaced radially from the rotation axis of the drive wheel; and
a plunger engaged by the second end of the crank such that the crank causes translation of the plunger between at least a retracted position and an actuated position when the drive wheel rotates in one direction of rotation about the rotation axis and the crank pivots about the pivot axis.

2. The actuator of claim 1 further comprising:
a slider coupled to the second end of the crank and slidably engaging the plunger such that the slider is slidable relative to the plunger when moving in an actuation direction; and
a spring element engaged between the slider and the plunger such that the slider engages the spring element and the spring element engages the plunger to cause translation of the plunger.

3. The actuator of claim 1 wherein the drive wheel is a worm drive wheel, and further comprising a worm gear engaging the worm drive wheel and coupled to the electric motor, wherein the worm gear causes the worm drive wheel to rotate about the rotation axis when the worm gear is driven by the electric motor.

4. The actuator of claim 3 further comprising a gear train coupled between the electric motor and the worm gear.

5. The actuator of claim 1 further comprising a radial arm coupled to the drive wheel at the rotation axis and coupled to the crank at the pivot axis.

6. The actuator of claim 1 further comprising:
a magnetic element fixed to the drive wheel such that the magnetic element rotates with the drive wheel; and
at least one magnetic sensor positioned such that the magnetic element passes the magnetic sensor when the drive wheel rotates for detecting a position.

7. The actuator of claim 6 wherein the at least one magnetic sensor includes first and second magnetic sensors, wherein the magnetic element is positioned at the first magnetic sensor when the plunger is in the retracted position and wherein the magnetic element is positioned at the second magnetic sensor when the plunger is in the actuated position.

8. The actuator of claim 1 wherein the electric motor rotates only in the one direction.

9. An actuator comprising:
a worm gear;
a worm drive wheel engaged by the worm gear and rotatable about a rotation axis;
an electric motor for driving the worm gear such that worm gear drives the worm drive wheel about the rotation axis;
a crank having a first end and a second end, the first end being pivotably coupled to the drive wheel such that the crank pivots about a pivot axis, the pivot axis being parallel to and spaced radially from the rotation axis of the drive wheel;
a slider coupled to the second end of the crank such that rotation of the drive wheel in one direction of rotation causes the crank to move the slider linearly in an actuation direction and in a retraction direction opposite the actuation direction;
a spring element engaging the slider;
a plunger engaged by the spring element such that translation of the slider in the actuation direction causes the spring element to move the plunger in the actuation direction to an actuated position and translation of the slider in the retraction direction causes the plunger to move in the retraction direction to a retracted position;
a magnetic element fixed to the drive wheel such that the magnetic element rotates with the drive wheel; and
at least one magnetic sensor positioned such that the magnetic element passes the magnetic sensor when the drive wheel rotates for detecting a position of the plunger.

10. The actuator of claim 9 wherein the at least one magnetic sensor includes first and second magnetic sensors, wherein the magnetic element is positioned at the first magnetic sensor when the plunger is in the retracted position and wherein the magnetic element is positioned at the second magnetic sensor when the plunger is in the actuated position.

11. A torque transfer system comprising:
a first shaft;
a second shaft for transmitting torque to the first shaft;
a coupling sleeve configured to move between engaged and disengaged positions relative to the first and second shafts, the sleeve coupling the first and second shafts for transmission of torque therebetween in the engaged position and being decoupled from at least one of the first and second shafts in the disengaged position;
an actuator for causing the sleeve to move between the engaged and disengaged positions, the actuator comprising:
a drive wheel rotatable about a rotation axis;
an electric motor for driving the drive wheel such that the drive wheel rotates about the rotation axis;
a crank having a first end and a second end, the first end being pivotably coupled to the drive wheel such that the crank pivots about a pivot axis, the pivot axis being parallel to and spaced radially from the rotation axis of the drive wheel; and
a plunger engaged by the second end of the crank such that the crank causes translation of the plunger between at least a retracted position and an actuated position when the drive wheel rotates in one direction of rotation about the rotation axis and the crank pivots about the pivot axis.

12. The system of claim 11 wherein the first shaft is a differential output shaft and the second shaft is a wheel output shaft.

13. The system of claim 11 wherein the coupling sleeve is a splined ring.

14. The system of claim 11 wherein the actuator further comprises:
a slider coupled to the second end of the crank and slidably engaging the plunger such that the slider is slidable relative to the plunger when moving in an actuation direction and engages the plunger when moving in a retraction direction; and
a spring element engaged between the slider and the plunger such that the slider engages the spring element and the spring element engages the plunger to cause translation of the plunger.

15. The system of claim 11 wherein the drive wheel is a worm drive wheel, and further comprising a worm gear engaging the worm drive wheel and coupled to the electric motor, wherein the worm gear causes the worm drive wheel to rotate about the rotation axis when the worm gear is driven by the electric motor.

16. The system of claim 11 wherein the actuator further comprises:
a magnetic element fixed to the drive wheel such that the magnetic element rotates with the drive wheel; and
at least one magnetic sensor positioned such that the magnetic element passes the magnetic sensor when the drive wheel rotates for detecting a position.

17. The system of claim 16 wherein the at least one magnetic sensor includes first and second magnetic sensors, wherein the magnetic element is positioned at the first magnetic sensor when the plunger is in the retracted position and wherein the magnetic element is positioned at the second magnetic sensor when the plunger is in the actuated position.

18. The system of claim 11 wherein the electric motor rotates only in the one direction.
